(19) United States
(12) Patent Application Publication
(10) Pub. No.: US 2017/0289662 A1
(43) Pub. Date: Oct. 5, 2017

(54) SPEAKER BRACKET

(71) Applicant: JANSON COMPUTERS PLC, London Greater London (GB)

(72) Inventors: Graham HANNATH, London (GB); Anthony JONES, London (GB)

(73) Assignee: JANSON COMPUTERS PLC, London Greater London (GB)

(21) Appl. No.: 15/508,616

(22) PCT Filed: Sep. 2, 2015
(86) PCT No.: PCT/GB2015/052531

§ 371 Date: Mar. 3, 2017

(30) Foreign Application Priority Data
Sep. 3, 2014 (GB) 1415597.2

(51) Int. Cl. H04R 1/02; F16M 11/04; F16M 11/10; H04R 1/32; F16M 13/02

(52) U.S. Cl. CPC H04R 1/026; H04R 1/323; F16M 13/022; F16M 11/10; F16M 11/041; H04R 2201/021; H04R 2201/025

(57) ABSTRACT

Speaker bracket comprising an attachment body (2) having a pivot column formed within a recessed channel. An arm assembly is provided comprising a tiltable inner arm portion (4) at least partially housed within an outer arm portion (3). The outer arm portion has a pivot channel into which the pivot column is received for connecting the arm assembly to the attachment body (2) and permitting it to swivel about the pivot column. A rotatable assembly is provided comprising an interface plate (6) connected to the front of the inner arm portion (4) and a speaker fixing plate (8) for attachment to a speaker and being rotatably connected to the interface plate (6) through a shaft (9) and fastener. The shaft (9) and fastener are at least partially received within a cavity in the front of the inner arm portion (4).

The present invention concerns a speaker bracket for mounting a speaker to a surface, such as a wall or ceiling and, in particular, concerns a rotatable articulated speaker bracket for a wireless speaker unit which allows the speaker to be rotated for accessing the speaker's controls and for the speaker to be detached from the bracket without requiring tools.

Conventional speaker mounts or brackets are commonly used to mount audio speakers to walls. This allows the speaker to be lifted up, out of the way, so that they do not occupy floor space. For example, a user may have their audio source, such as a Hi-fi or TV system, positioned on a stand on one side of a room, and then wire and mount the associated speakers high up in two or more corners of the room. This thereby increases the distance between the speakers to provide better sound distribution.

In order to optimally deliver sound it is also known for some conventional speaker brackets to allow the speaker to swivel in a horizontal plane so that the front face of the speaker can be directed toward different parts of a room. Equally, some conventional speaker brackets also allow the speaker to be tilted forward for directing the sound at a downward angle. This allows the speaker to be mounted higher up in a room, for example ideally above head height to optimise space, whilst ensuring the front face of the speaker is still directed towards a user for optimum sound delivery.

While the above described conventional speaker brackets are effective for traditional wired audio systems, the present inventors have identified an issue with this type of bracket arising from the use of digital music sources and the adoption of wireless technology, such as Wi-Fi and Bluetooth, into audio systems and speaker units.

In this respect, traditionally a user may have had a Hi-Fi system with a CD player and central amplifier that was used to power two speakers via wire connections. With such a system, once the speakers were mounted and positioned, a user could simply control the delivery of sound though the Hi-Fi's base unit, without need to physically access the speakers. However, as the use of digital music and streaming services has increased, it is becoming more common for users to play music or other audio from computing devices, such as laptops, mobile phones and tablets. Consequently, rather than having a single conventional Hi-Fi, many users now use their computing devices to play music through an integrated speaker unit which has an inbuilt amplifier. As this practice has developed, manufacturers of such integrated speakers have gone on to incorporate wireless technology to allow audio to be delivered to the speaker without a user having to physically connect their computing device. This is particularly useful for mobile computing devices where a user may wish move the device around or between rooms.

With such wireless speakers, audio is delivered to the unit as a wireless data signal, which is then processed and amplified internally by processors within the unit. However, as a consequence of this, it is necessary to provide controls, such as power and/or volume controls, on the speaker unit itself to allow a user to, for example, adjust the output volume or turn the speaker off when not in use. The present inventors have recognised, however, that when such speaker units are then mounted using a conventional wall bracket, it can be difficult to access these controls. For example, if the speaker is mounted high up in the corner of a room, it can be difficult for many users to then easily reach the speaker's controls.

At the same time as the above, when such wireless speaker units are mounted, it can sometimes be difficult to detach the speaker unit from the bracket. Indeed, since there was no need for conventional speakers to be temporarily detached, many conventional brackets simply fix the speaker in place using screws. However, with wireless speaker units, it can often be necessary to detach them temporarily, for example, to allow the unit to be recharged or moved to another room.

The present invention therefore seeks to address the above issues with conventional speaker brackets.

According to an aspect of the present invention there is provided a speaker bracket for mounting a speaker to a wall, the speaker bracket comprising: an attachment body for attachment to a wall and having a front comprising a pivot column formed within a recessed channel; an arm assembly comprising an outer arm portion, an inner arm portion at least partially housed within the outer arm portion, and a lockable tilt mechanism, the outer arm portion having a pivot channel into which the pivot column is received for connecting the arm assembly to the attachment body and permitting it to swivel about the pivot column, and the lockable tilt mechanism for allowing the inner arm portion to be tilted out from the outer arm portion, wherein the front of the inner arm portion further comprises a cavity; a rotatable assembly comprising an interface plate fixably connected to the front of the inner arm portion and a speaker fixing plate for attachment to a speaker and being rotatably connected to the interface plate through a shaft and fastener for allowing an attached speaker to be rotated relative to the arm assembly, wherein the shaft and fastener compress a friction washer between the interface plate and the speaker fixing plate for holding an attached speaker at a selected rotated position, and wherein the shaft and fastener are at least partially received within the cavity in the front of the inner arm portion.

In this way, a speaker bracket is provided which allows a mounted speaker to be swivelled laterally to both the left and right, tilted forwards, and to be manually rotated by a user. This allows the controls and ports provided on the sides of the speaker to be easily accessed, even when the speaker is mounted to the bracket. In addition, because the swivel functionality is provided by the hinge arrangement formed between the pivot channel and pivot column, this can allow the speaker to be detached from its mounted position by lifting the pivot channel off the pivot column, without the need for a user to access tools. Moreover, because the attachment body has a depth to accommodate the recessed channel, its structural strength is improved, whilst still allowing the axis of rotation of the swivelling arm assembly, as defined by the pivot column, to be set very near to the wall surface. This, in combination with the inner arm portion being partially received within the outer arm portion, and the shaft and fastener being at least partially received within the inner arm portion's cavity, provides for a very slim line, compact, construction.

In an embodiment, the front of the attachment body further comprises a locking channel formed circumferentially around the bottom of the pivot column, and the outer arm portion further comprising an engagement formation biassed into locking engagement within the locking channel when the pivot column is fully received within the pivot channel and being laterally slidable along the locking channel when the arm assembly is swivelled about the pivot column, wherein engagement formation is manually disengagable from the locking channel for permitting the outer arm portion to be detached from the pivot column. In this way, the locking channel extends across the base of the pivot column and ensures the arm assembly remains securely locked to the attachment body as it swivels between left and right. If a user wishes to detach the speaker, they then simply need to manually disengage the engagement formation, for example by depressing it, which then allows the pivot channel to be lifted off the pivot column.

In an embodiment, the engagement formation is integrally formed in a bottom surface of the outer arm portion. This avoids the need to attach a separate locking mechanism.

In an embodiment, the attachment body further comprises a sliding platform at the bottom of the recessed channel for supporting the outer arm portion, the outer arm portion being slidably moveable across the sliding platform when swivelled about the pivot column. In this way, the outer arm portion is braced by the sliding platform, thereby sharing the forces applied though the arm assembly to the pivot column with the base of the attachment body. This makes the bracket less liable to fail, as well as easing the swivelling action between the pivot channel and pivot column.

In an embodiment, the arm assembly is at least partially received within the recessed channel of the attachment body such that sides of the recessed channel define the lateral extremities to which the arm assembly can be swivelled about the pivot column. In this way, the bracket is less liable to fail because the lateral movement is limited by engagement over the larger surface area of the sides of the arm assembly with the attachment body, rather than solely though the pivot channel. At the same time, the bracket is provided with a more compact profile.

In an embodiment, the interface plate comprises keying formations which inter engage with corresponding formations on the front of the inner arm portion for supporting the interface plate so as to prevent relative movement between the interface plate and the inner arm portion. This allows a metal interface plate to be used in combination with a polymer inner arm portion, without the relative differences in stiffness between these materials compromising the connection between them. That is, the keying formations help to distribute rotational and load bearing forces across the front face of the inner arm portion to prevent distortion in this component.

In an embodiment, the lockable tilt mechanism comprises a tilt locking screw for compressing the sides of the outer arm portion into engagement with the sides of the inner arm portion for holding the inner arm portion at a selected tilted position. This allows the outer arm portion to both house and fixably lock the inner arm portion in a tilted position.

In an embodiment, the outer arm portion further comprises a compression slit for facilitating the inward compression of the sides of the outer arm portion. This reduces the forces required to compress the sides of the outer arm portion together for locking the tilt of the inner arm portion. This thereby minimises the risk of material failure within the outer arm portion.

In an embodiment, the pivot channel and pivot column are sized for a dead fit for resisting swivelling of the arm assembly unless manually moved by a user. In this way, an attached speaker is held in a selected position unless actively moved by a user.

In an embodiment, the rear of the pivot column is connected to the recessed channel through a vertical support and the pivot channel comprises a vertical slit at its rear for accommodating the vertical support when the outer arm portion is swivelled about the pivot column. In this way, the pivot column is supported at its rear through the height of the column, thereby allowing load forces to be effectively and evenly transferred to the attachment body, and hence minimising the risk of component failure.

In an embodiment, the shaft of the rotatable assembly is a threaded shaft and the fastening comprises a nyloc nut tightened to a predetermined torque for compressing the friction washer between the interface plate and the speaker fixing plate so that rotation of the speaker fixing plate is resisted unless manually moved by a user. In this way, an attached speaker is held in a selected position unless actively moved by a user.

In an embodiment, one or more of the attachment body, the outer arm portion, and the inner arm portion are formed as integral polymer moulding. In this way, the complex geometric features within these components can be easily formed though a polymer moulding process, such as injection moulding, while minimising the overall bracket weight.

In an embodiment, one or more of the interface plate and the speaker fixing plate is formed from metal. In this way, additional rigidity is provided in the rotating components.

In an embodiment, the friction washer is a fibre washer.

An illustrative embodiment of the present invention will now be described with reference to the accompanying drawings in which:

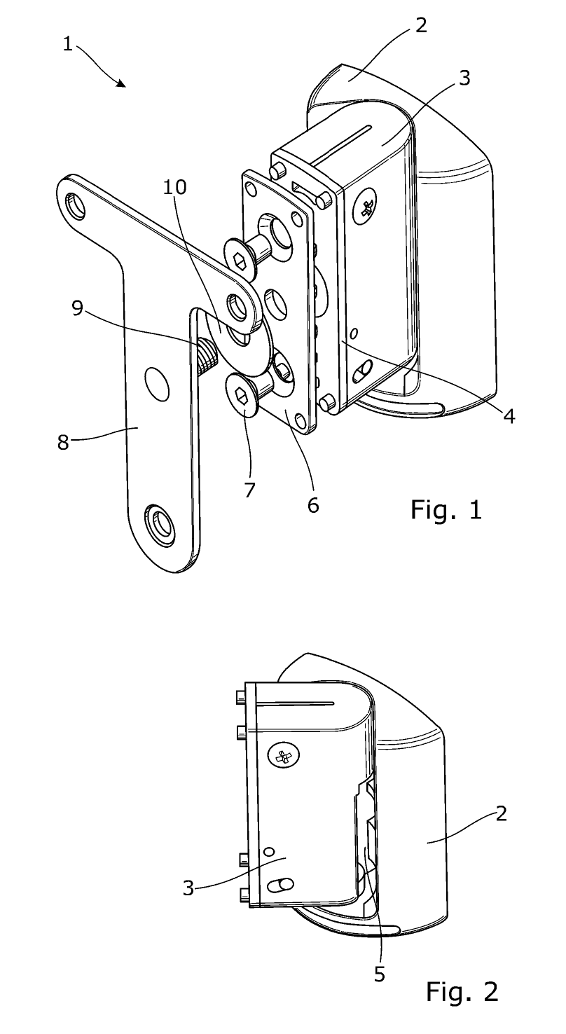

FIG. 1 shows a partially exploded perspective view of a speaker bracket according to an embodiment of the invention;

FIG. 2 shows the attachment body and arm assembly in a swivelled position;

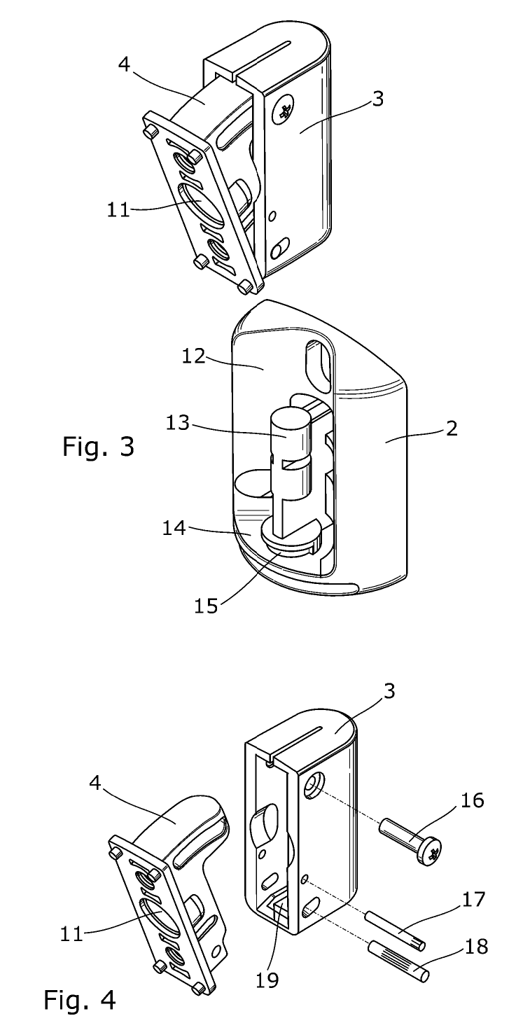

FIG. 3 shows a perspective view of the separated arm assembly and attachment body;

FIG. 4 shows an exploded perspective view of the arm assembly;

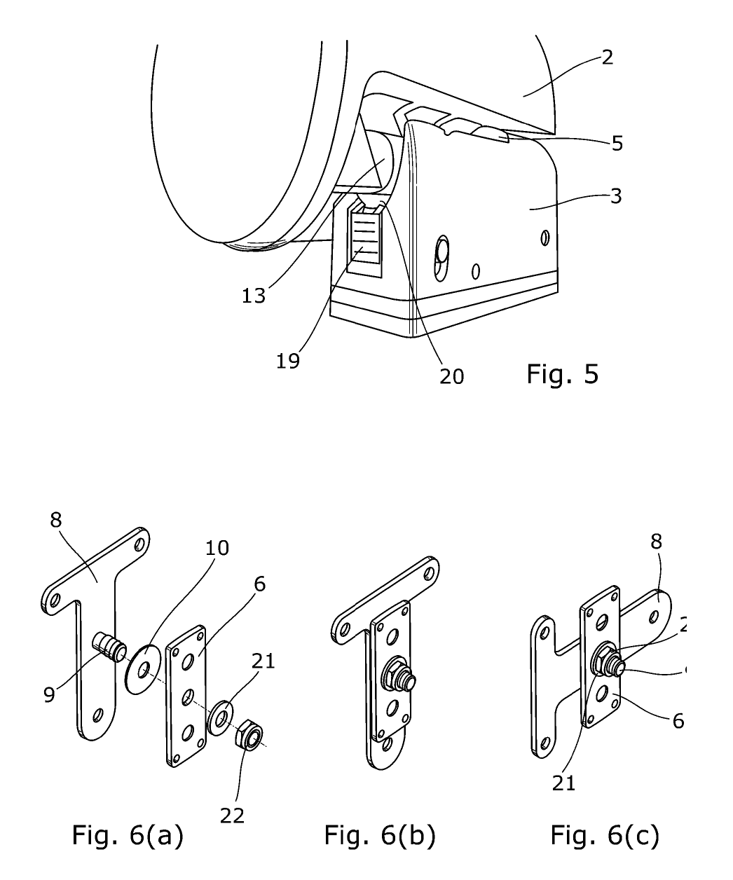

FIG. 5 shows the bottom of the arm assembly partially connected to the attachment body;

FIG. 6 shows (a) an exploded perspective view of the rotatable assembly, (b) the rotatable assembly in a vertical position, and (c) the rotatable assembly rotated to a horizontal position;

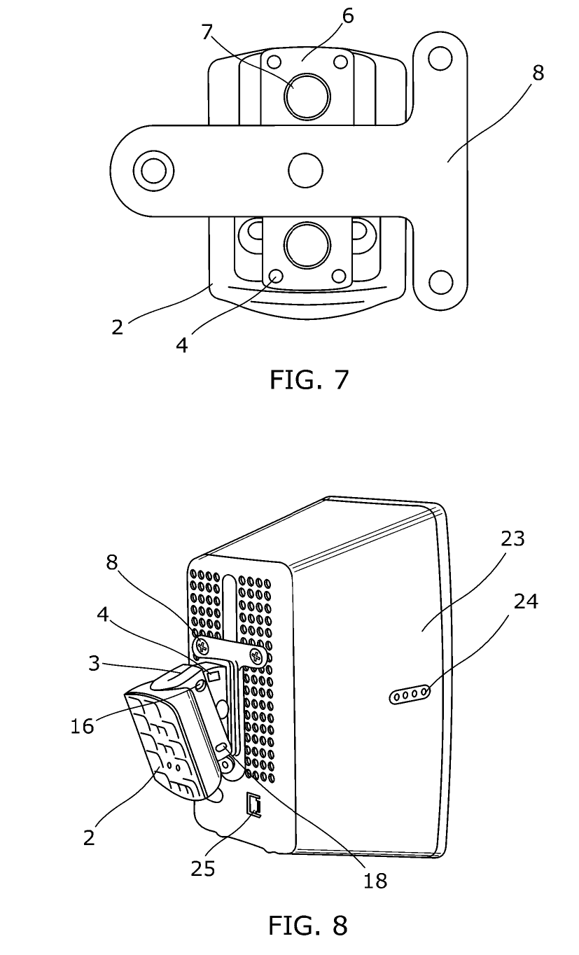

FIG. 7 shows a front view of the assembled bracket with the rotatable assembly rotated to a horizontal position;

FIG. 8 shows a rear perspective view of the bracket connected to a speaker, with the arm assembly in the tilted position and the rotatable assembly in a vertical position; and

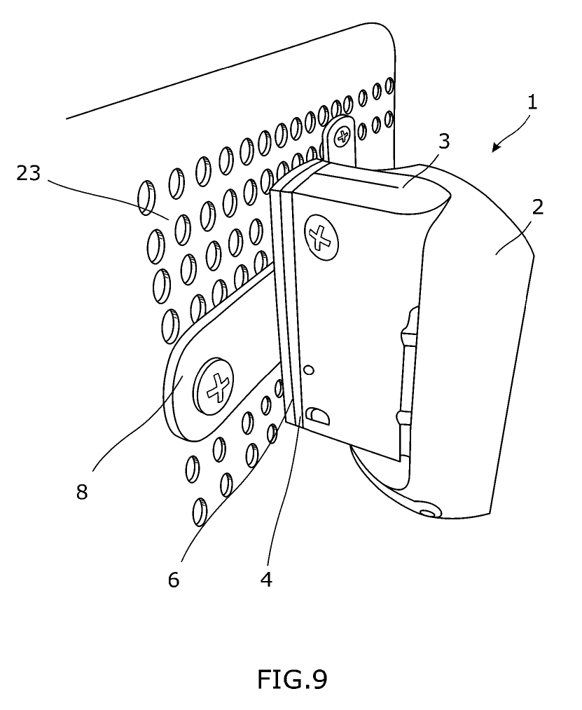

FIG. 9 shows a rear perspective view of the bracket connected to a speaker, with the arm assembly in a swivelled position and the rotatable assembly rotated to a horizontal position.

FIG. 1 shows the speaker bracket 1 according to an embodiment of the invention. The speaker bracket 1 comprises three main sections; an attachment body 2, an arm assembly and a rotatable assembly. The attachment body 2 is for attachment to a wall and provides a base for supporting the arm assembly, the rotatable assembly and an attached speaker. The arm assembly comprises an outer arm portion 3 and an inner arm portion 4, and the rotatable assembly comprises an interface plate 6 and a speaker fixing plate 8. The arm assembly is moveably connected to the attachment body 2 to allow it to swivel through a horizontal plane. The fixed plate 6 is fixed to the inner arm portion 4 of the arm assembly by screws 7. The speaker fixing plate 8 is rotatably connected to the fixed plate 6 through threaded shaft 9 and a nyloc nut (not shown here). Fibre washer 11 is positioned between the speaker fixing plate 8 and the fixed interface plate 6.

FIG. 2 shows the arm assembly 3 connected to the attachment body 2, with the arm having been moved by swivelling it to the attachment body's right side.

FIG. 3 shows the arm assembly 3 and the attachment body 2 when separated. The attachment body 2 is formed as an integral moulding with a recessed channel 12 on its front face, with the channel having an open top and a closed bottom 14 which provides a sliding surface for the outer arm portion 3 of the arm assembly. Within the recessed channel 12 is provided pivot formation 13 which forms a column about which the arm assembly pivots. The column part of the pivot formation 13 is connected at its rear to the base of the recessed channel 12 by a vertical strut. In use, the attachment body 2 may be fixed to a wall using screws.

As shown in FIGS. 3 and 4, the arm assembly comprises outer and inner arm portions, each formed as integral polymer mouldings. The outer arm portion 3 houses the inner arm portion 4, with the rear part of the inner arm portion 4 fitting inside the outer arm portion 3 for hiding the tilt mechanism when not in use. The inner arm portion 4 is able to pivot or tilt outwardly from the outer arm portion 3 about tilt pin 18. The outer arm portion 3 is provided with a slit in its top panel which allows its sides to be moved together under a compressive force from tilt locking screw 16. As such, the tilt locking screw 16 can be tightened to squeeze the sides of the outer arm portion 3 against the sides of the inner arm portion 4. This allows the inner arm portion 4 to be locked to hold it at a fixed tilted position relative to the outer arm portion 3. Safety stop pin 6 prevents the inner arm portion 4 from disengaging entirely from the outer arm portion. The front face of the inner arm portion 4 is provided with four projections which correspond to and key with apertures provided in the interface plate 6 for supporting it. A cavity 11 is also provided in the centre of the front face of the inner arm portion 4 for accommodating the threaded shaft 9 and nyloc nut of the rotatable assembly. This hides the rotating mechanisms and helps to provide a compact, slim-line bracket for minimising the distance from which the speaker projects from a wall.

As shown in FIG. 2, the rear surface of outer arm portion 3 is provided with a channel 5 which opens at the bottom of the outer arm portion 3. FIG. 5 shows a perspective view of the bottom of the attachment body and arm assembly when they are partially connected. As shown, the arm assembly is connected to the attachment body 2 by sliding the outer arm portion 3 down over the pivot formation 13 so that the pivot formation 13 is engaged within the channel 5. The pivot formation 13 of the attachment body 2 and the channel of the outer arm portion 3 are designed to dead fit, thereby allowing the outer arm portion 3 to swivel within the attachment body 2, but giving the swivel action enough friction to hold a speaker in place unless actively moved by a user.

As shown in FIGS. 4 and 5, the bottom of outer arm portion 3 is provided with a locking tooth 19 which has an engagement end and a button for moving the engagement end. When the arm assembly is slid fully down over the pivot formation 13, the end of the locking tooth 19 engages into the locking channel 15 provided around the bottom of the pivot formation 13, as shown in FIG. 3. This mechanically locks the arm assembly to the attachment body. Furthermore, as the locking channel 15 extends circumferentially around the bottom of pivot formation 13, the locking tooth 19 remains engaged within the channel 15 when the arm assembly is swivelled laterally. To disconnect the arm assembly from the attachment body 2, a user presses the button part of the locking tooth 19 to disengage the end of the locking tooth from the locking channel 15, thereby allowing the arm assembly to be slid upwardly off the pivot formation 13.

FIG. 6 shows the rotatable assembly. In FIG. 6(a) the components of the rotatable assembly have been separated. The speaker fixing plate 8 has three speaker attachment holes which can be used to connect the outward face of the plate to a speaker unit using screws or bolts. The inward facing surface of the speaker fixing plate 8 is provided with an integrally formed threaded shaft 9 projecting rearwardly from it. The threaded shaft 9 fits through a fibre washer 10, a central aperture provided in interface plate 6, and a washer 21, and a nyloc nut 22 is screwed onto the threaded shaft to hold the assembly together as shown in FIG. 6(b). The nyloc nut 22 is tightened to a pre-set torque, and the fibre washer 10 compressed between the speaker fixing plate 8 and the interface plate 6 then provides a friction surface for maintaining the speaker fixing plate 8 in positions relative to the interface plate 6.

As shown in FIG. 6(c), the rotatable assembly allows the speaker fixing plate 8 to be manually rotated relative to the interface plate 6. Once rotated, the friction at the interface between the speaker fixing plate 8, fibre washer 10 and the interface plate 6 acts to hold the speaker fixing plate 8 in a desired position. The rotatable assembly in this embodiment allows the speaker fixing plate 8 to be rotated a full 360 degrees.

FIG. 7 shows a front view of the assembled bracket without a speaker unit attached. As shown, the interface plate 6 has been secured onto the front face of the inner arm portion 4 using screws 7, with the four corner projections provided on the inner arm portion 4 keying into the four corner apertures in the interface plate 6. This prevents the interface plate 6 moving relative to the arm assembly and attachment body 2 which supports it. As shown, the speaker fixing plate 8 has been rotated to a horizontal position.

FIG. 8 shows a perspective view of the rear of the bracket 1 when connected to a speaker unit 23. The front of the speaker fixing plate 8 has been connected to the rear of the speaker 23 using screws. The rotatable assembly is in its normal position so that the speaker fixing plate 8 is held vertically relative to the interface plate 6. In this figure, the arm assembly has been moved into a tilted position, with the inner arm portion 4 being tilted out from the outer arm portion 3 and held in place by tilt pin 18 and tilt locking screw 16. The outer arm portion 3 is connected to the attachment body 2.

As shown, the speaker unit 23 includes controls 24 for controlling the power and volume of the unit, as well as connector port 25, which may be used to connect the speaker to a computer or computer network or may be a power port for recharging the unit.

In use, the attachment body 2 may be attached to a wall or other surface using fixing formations provided on its rear surface. As discussed above, a user is able to then position an attached speaker unit 23 by swivelling the arm assembly laterally within the channel 12 provided in attachment body 2, and by tilting the inner arm portion 4 out from outer arm portion 3.

In addition to the above, a user is also able to manually rotate the speaker unit 23 through the rotatable assembly, with the speaker unit then being held in a rotated position using the mechanism discussed above in reference to FIG. 6. In particular, when a speaker unit 23 is attached to the speaker fixing plate 8, the tightened nyloc nut 22 applies sufficient compressive force to the fibre washer 10 between the interface plate 6 and speaker fixing plate 8 to hold the speaker in a rotated position. As such, once a user moves the mounted speaker unit through rotation of speaker fixing plate 8 to a desired rotated position, the friction at the fibre washer 10 then resists further rotation of the speaker. Furthermore, the fibre washer also acts to prevent further movement of the speaker due to vibrations, for instance from the audio output by the speaker.

FIG. 9 shows close up view of the rear of the speaker unit 23 and bracket 1 when the speaker has been rotated to horizontal and with the arm assembly being swivelled to the right.

With the above arrangement, if the speaker is mounted high up on a wall, a user can rotate the speaker around so that it is in a horizontal or landscape position, with the controls 24 facing down. This thereby allows the user to more easily access the controls 24 on the side of the speaker unit 23. Similarly, if the arm assembly has been tilted outwardly to maximum tilt and the speaker unit 23 is held in a vertical portrait position, as shown in FIG. 8, the connector port 25 may also be difficult to access. This is because the bottom of the speaker 23 will be positioned relatively close to the wall to which the speaker 23 is mounted. In such an instance, the present invention allows the speaker unit to be rotated to bring the connector port temporally away from the wall, allowing the user to connect a connector, before moving the speaker 23 back to its vertical position. Furthermore, the rotatable assembly allows the speaker unit to be moved between portrait and landscape positions and also for fine levelling.

Moreover, if a user wishes to dismount the speaker unit 23 from the bracket 1, as discussed in relation to FIGS. 4 and 5, they are able to press on locking tooth 19 to then allow the arm assembly to be slid vertically up off the attachment body's pivot formation 13. As such, the speaker unit 23, along with the arm and rotatable assemblies, can be easily detached and reattached from the attachment body 2 without a user needing tools to do so. A user is therefore able to detach the speaker unit without needing a screw driver and without having to alter their set tilt or rotated positioning. As such, the speaker unit 23 may be easily removed from and remounted to its bracket as and when the user requires. It also allows for simplified mounting of the attachment body 2 to a wall or ceiling because the moveable parts of the bracket, as well as the speaker unit 23 itself, can be detached. This avoids these parts getting in the way when a user is trying to secure and level the attachment body 2 to masonry or other building structures.

Importantly, in addition to providing the above functionality, the disclosed bracket arrangement has a very slim and compact profile. This avoids the speaker projecting far from the surface of the wall to which it is mounted, which would otherwise be undesirable in terms of the space used and the bracket's appearance. In particular, the recessed channel 12 and pivot formation 13 within the attachment body 2 allow the outer arm portion 3 to be partially accommodated within the attachment body 2, and for the axis about which the arm assembly swivels to be far back into the rear of the attachment body, close to the mounting wall. At the same time, the inner arm portion 4 is partially accommodated within the outer arm portion 3. Similarly, the cavity 11 within the inner arm portion 4 accommodates the threaded shaft 9 and nyloc nut 22 of the rotatable assembly, and the corner projections on the inner arm portion 4 help to secure the interface plate 6 in place with a slim profile. The combination of these features allows for a particularly slim line bracket, which is also highly adjustable.

It will be understood that the embodiment illustrated above shows applications of the invention only for the purposes of illustration. In practice the invention may be applied to many different configurations, the detailed embodiments being straightforward for those skilled in the art to implement. For example, although the present invention has been described in reference to mounting the bracket to a vertical wall, it will be understood that the claimed bracket could be also mounted to a horizontal wall surface, such as a ceiling.

1. A speaker bracket for mounting a speaker to a wall, the speaker bracket comprising:
an attachment body for attachment to a wall and having a front comprising a pivot column formed within a recessed channel;
an arm assembly comprising an outer arm portion, an inner arm portion at least partially housed within the outer arm portion, and a lockable tilt mechanism, the outer arm portion having a pivot channel into which the pivot column is received for connecting the arm assembly to the attachment body and permitting it to swivel about the pivot column, and the lockable tilt mechanism for allowing the inner arm portion to be tilted out from the outer arm portion, wherein the front of the inner arm portion further comprises a cavity;
a rotatable assembly comprising an interface plate fixably connected to the front of the inner arm portion and a speaker fixing plate for attachment to a speaker and being rotatably connected to the interface plate through a shaft and fastener for allowing an attached speaker to be rotated relative to the arm assembly, wherein the shaft and fastener compress a friction washer between the interface plate and the speaker fixing plate for holding an attached speaker at a selected rotated position, and wherein the shaft and fastener are at least partially received within the cavity in the front of the inner arm portion.

2. A speaker bracket according to claim 1, wherein the front of the attachment body further comprises a locking channel formed circumferentially around the bottom of the pivot column, and the outer arm portion further comprising an engagement formation biased into locking engagement within the locking channel when the pivot column is fully received within the pivot channel and being laterally slidable along the locking channel when the arm assembly is swivelled about the pivot column, wherein the engagement formation is manually disengagable from the locking channel for permitting the outer arm portion to be detached from the pivot column.

3. A speaker bracket according to claim 1, wherein the engagement formation is integrally formed in a bottom surface of the outer arm portion.

4. A speaker bracket according to claim 1, wherein the attachment body further comprises a sliding platform at the bottom of the recessed channel for supporting the outer arm portion, the outer arm portion being slidably moveable across the sliding platform when swivelled about the pivot column.

5. A speaker bracket according to claim 1, wherein the arm assembly is at least partially received within the recessed channel of the attachment body such that sides of the recessed channel define the lateral extremities to which the arm assembly can be swivelled about the pivot column.

6. A speaker bracket according to claim 1, wherein the interface plate comprises keying formations which interengage with corresponding formations on the front of the inner arm portion for supporting the interface plate so as to prevent relative movement between the interface plate and the inner arm portion.

7. A speaker bracket according to claim 1, wherein the lockable tilt mechanism comprises a tilt locking screw for compressing the sides of the outer arm portion into engagement with the sides of the inner arm portion for holding the inner arm portion at a selected tilted position.

8. A speaker bracket according to claim 7, wherein the outer arm portion further comprises a compression slit for facilitating the inward compression of the sides of the outer arm portion.

9. A speaker bracket according to claim 1, wherein the pivot channel and pivot column are sized for a dead fit for resisting swivelling of the arm assembly unless manually moved by a user.

10. A speaker bracket according to claim 1, wherein the rear of the pivot column is connected to the recessed channel through a vertical support and the pivot channel comprises a vertical slit at its rear for accommodating the vertical support when the outer arm portion is swivelled about the pivot column.

11. A speaker bracket according to claim 1, wherein the shaft of the rotatable assembly is a threaded shaft and the fastening comprises a nyloc nut tightened to a predetermined torque for compressing the friction washer between the interface plate and the speaker fixing plate so that rotation of the speaker fixing plate is resisted unless manually moved by a user.

12. A speaker bracket according to claim 1, wherein one or more of the attachment body, the outer arm portion, and the inner arm portion are formed as integral polymer moulding.

13. A speaker bracket according to claim 1, wherein one or more of the interface plate and the speaker fixing plate is formed from metal.

14. A speaker bracket according to claim 1, wherein the friction washer is a fibre washer.

15. (canceled)
